(19) United States
(12) Patent Application Publication
(10) Pub. No.: US 2011/0246682 A1
(43) Pub. Date: Oct. 6, 2011

(54) MANAGEMENT SYSTEM OF REMOVABLE DEVICE, MANAGEMENT METHOD OF REMOVABLE DEVICE, AND NON-TRANSITORY READABLE-BY-COMPUTER RECORDING MEDIUM

(75) Inventors: Shinichiro Kamimaru, Kahoku-shi (JP); Minetaka Rokutanda, Kahoku-shi (JP); Satoru Arai, Kahoku-shi (JP)

(73) Assignee: PFU LIMITED, Kahoku-shi (JP)

(21) Appl. No.: 12/894,787

(22) Filed: Sep. 30, 2010

(30) Foreign Application Priority Data
Mar. 30, 2010 (JP) 2010-078765

(51) Int. Cl. G06F 15/16; G06F 13/10

(52) U.S. Cl. 710/16; 709/219

(57) ABSTRACT

To enable management of a removable device detachably provided in an information processing device. An information processing terminal monitors a connection status of a removable device detachably connected to the information processing terminal itself, then acquires, when the removable device is connected thereto, device information related to the removable device from a predetermined storage unit, and transmitting the device information to the management server via the network, while the management server registers the device information received from the information processing terminal in the way of being associated with information of the sender information processing terminal in a database, and outputs management information on the basis of the device information.

### CROSS-REFERENCE TO RELATED APPLICATION

This application is based upon and claims the benefit of priority of the prior Japanese Patent Application No. 2010-078765, filed on Mar. 30, 2010, the entire contents of which are incorporated herein by reference.

### FIELD

The present invention relates to a technology of managing a removable device which is detachably provided in an information processing device.

### BACKGROUND

In an environment where a plurality of computer terminals is connected to a network, a known method is such that in order to streamlining installing work of software and updating work they are managed collectively by a server, wherein software and updater are registered in the server in advance, then, when access from a client to the server is made, software is automatically installed from the server to the client, or the updater is distributed from the server to the client, thereby to automatically update the software.

### SUMMARY

[Patent document 1] Japanese Patent Laid-Open Publication No. H10-301786

### SUMMARY OF THE INVENTION

### Problems To Be Solved By the Invention

As described above, the terminal, which involves batchwise managing the installation and the update of the software through the server, is limited to the terminal connectable to the server via a network.

Therefore, the management of firmware of the removable device (which is a dynamically attachable/detachable device based on USB (Universal Serial Bus), SCSI (Small Computer System Interface), etc) not directly connected to the network, a driver and an application needed for this device (such as checking and installing the latest update data, applying the update data and changing setting values of the firmware information and the driving information), is conducted by a user of each terminal to which a removable device is connected, or by a system administrator in a way that checks round statuses of the respective terminals.

The former case has problems, in which the user of each terminal needs to examine management procedures (a firmware/driver status checking method, an installing procedure and an update method) by himself or herself, or the system administrator needs to request the user to carry out the operation by presenting the management procedures, resulting in a high risk of causing an operation mistake.

The latter case has such a problem that if the management target terminals and devices rise in their numbers, the system administrator is burdened with a tremendous operation load, resulting in an increase in management cost.

Further, the same operation needs performing on the occasion of unifying the setting values of the device, the driver and the application, which also causes a problem in terms of the system management on the occasion of unifying an operating environment.

It is an object of the present invention to manage, in view of the problems described above, a removable device which is detachably provided in an information processing device.

According to the present invention, an information processing device includes the following means in order to solve the problems described above. Namely, a management system of a removable device according to the present invention has a management server and an information processing terminal that are connected to each other via a network, in which the information processing terminal includes: a device information acquiring unit to monitor a connection status of a removable device which is detachably connected to the information processing terminal itself, and to acquire, when the removable device is connected thereto, device information related to the removable device from a predetermined storage unit; and a transmission control unit to transmit the device information to the management server via the network, and the management server includes: a device information registering unit to register the device information received from the information processing terminal in the way of being associated with information of the sender information processing terminal in a database; and a management unit to output management information on the basis of the device information.

The device information may contain at least one of identifying information of the removable device, a level (version) of firmware of the removable device, identifying information of a driver of the removable device, a version of the driver, identifying information of application software using the removable device, version information of the application software, a setting value related to the removable device and change information of the setting value.

The management server may include a distribution determining unit which is stored with, in the way of being added to the device information, applied information containing an applied condition of the device information and determines based on the applied information whether the device information should be distributed to the information processing terminal or not.

The management server may include a transmitting unit to transmit the device information to the information processing terminal, and the information processing terminal may include an applying unit to check a usage status of the removable device and to update the device information of the removable device with the device information received from the management server.

The management system of the removable device may further has: a setting information collecting unit to collect the setting information related to the removable device in the device information by reading the setting information from the predetermined storage unit of the removable device; and an information formatting unit to format the setting information related to the removable device in a data of a predetermined format and to transmit the formatted setting information to the management server.

Further, a management method of a removable device according to the present invention is executed by a management server and an information processing terminal that are connected to each other via a network, in which the information processing terminal executes: a step of monitoring a connection status of a removable device which is detachably connected to the information processing terminal itself, and acquiring, when the removable device is connected thereto, device information related to the removable device from a predetermined storage unit; and a step of transmitting the device information to the management server via the network, and the management server executes: a step of registering the device information received from the information processing terminal in the way of being associated with information of the sender information processing terminal in a database; and a step of outputting management information on the basis of the device information.

Still further, the present invention can be also grasped by way of a program for making a computer execute the respective steps of the management method of the removable device.

According to the present invention, it is feasible to manage the removable device that is detachably provided in the information processing device.

### BRIEF DESCRIPTION OF THE DRAWINGS

FIG. 1 is a diagram illustrating an architecture of a whole management system according to an embodiment.

FIG. 2 is a diagram illustrating an outline of a configuration of a user terminal 1.

FIG. 3 is a diagram illustrating an outline of a configuration of a management server 2.

FIG. 4 is a diagram illustrating an outline of a configuration of an administrator terminal 3.

FIG. 5(A), FIG. 5(B) are an explanatory flowchart illustrating a management method of a removable device.

FIG. 6(A), FIG. 6(B) are an explanatory flowchart illustrating the management method of the removable device.

FIG. 7 is an explanatory flowchart illustrating the management method of the removable device.

FIG. 8 is an explanatory diagram illustrating the management method of the removable device.

FIG. 9 is an explanatory diagram illustrating the management method of the removable device.

FIG. 10 is an explanatory diagram illustrating the management method of the removable device.

FIG. 11 is an explanatory diagram illustrating the management method of the removable device.

### DESCRIPTION OF EMBODIMENTS

An embodiment of a management system according to the present invention will hereinafter be described with reference to the drawings. The embodiment, which will hereinafter be described, represents one example of carrying out the present invention, but the present invention is not limited to a specific configuration that will hereinafter be discussed. It is preferable that the implementation of the present invention involves properly adopting the specific configuration corresponding to the embodiment.

<Architecture>

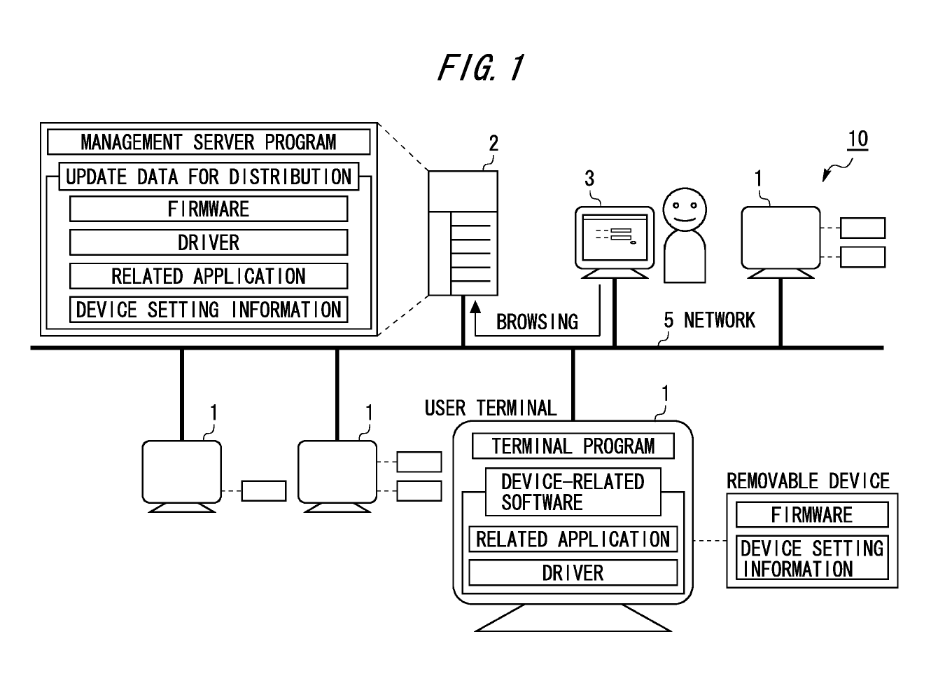

FIG. 1 is a view illustrating an architecture of a whole management system 10 according to the embodiment. The management system 10 according to the embodiment includes a user terminal (information processing terminal) 1, a management server 2 and an administrator terminal 3, which are connected to each other via a network 5. Note that the network 5 may be, if enabling communications to be performed between the user terminal 1 and the management server 2 and between the management server 2 and the administrator terminal 3, whatever type of network such as the Internet, a mobile phone network, a private line, a private network and an Intranet.

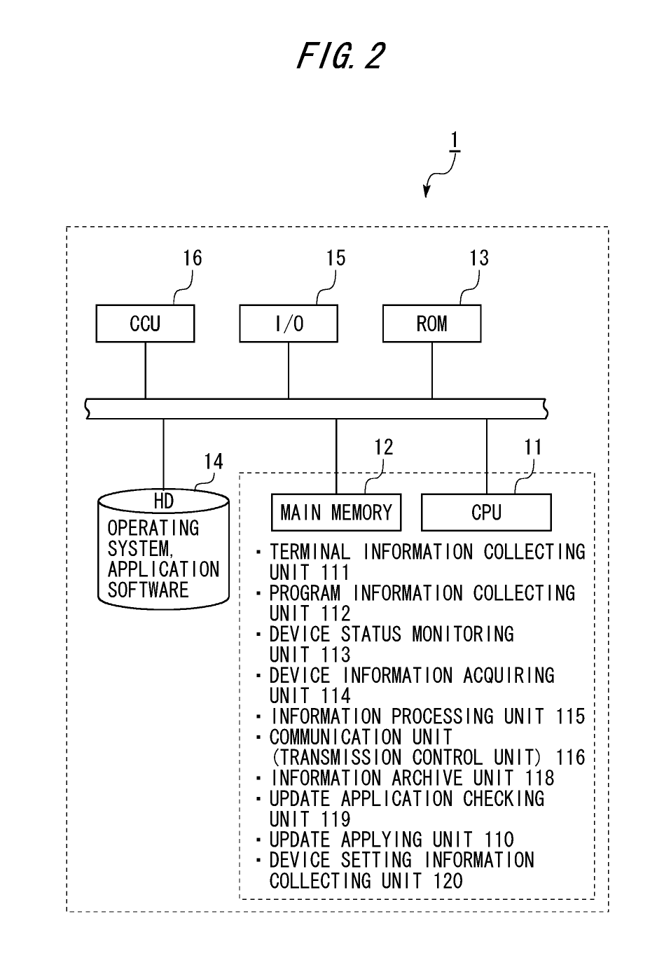

FIG. 2 is a diagram illustrating an outline of a configuration of the user terminal 1 according to the embodiment. The user terminal 1 is a so-called computer including a CPU (Central Processing Unit) 11, a RAM (Random Access Memory) 12, a ROM (Read Only Memory) 13, an auxiliary storage device 14, an Input/Output (I/O) interface 15 and a communication control unit 16.

The RAM 12 is a so-called main memory (main storage device) from and to which the CPU 11 reads and writes a variety of instructions and data.

The auxiliary storage device 14 is a storage device, which is permanently stored with a large quantity of information and auxiliary to the volatile RAM 12, and is exemplified by an HDD (Hard Disk Drive) and an SSD (Solid-State Drive).

The I/O interface 15 is an interface for establishing connections with input/output means and for inputting and outputting signals. The input means, which inputs the signals as the date to be processed by the CPU 11, is exemplified by: a pointing device such as a mouse and a touch panel; an operation unit such as a variety of buttons and dials; a storage medium reading device such as a CD-ROM drive and a memory card reader; a keyboard; a scanner; and a microphone.

Further, the output means, which outputs the signals as a result of the processing of the CPU 11, is exemplified by: a display device; a printer; a storage medium writing device such as a keyboard, an FD drive and a memory card writer; and a loudspeaker.

Note that the input/output means is, though an available I/O means is fixedly connected to the I/O interface 15, generally a removable device detachably connected to the I/O interface 15.

Standards of the I/O interface 15 are not particularly limited but may be, e.g., USB (Universal Serial Bus), SCSI (Small Computer System Interface) and IEEE1394 (Institute of Electrical and Electronic Engineers 1394). Namely, in the case of adopting the USB and the SCSI, the I/O interface 15 includes a USB controller and an SCSI controller.

The communication control unit 16 establishes the connections with other computers via the network 5, and controls the communications with other computers in accordance with an instruction given from the CPU 11.

The CPU 11 is a central processing unit and controls the RAM 12, the auxiliary storage device 14, the communication control unit 16, the input/output means, etc by processing the instructions and the data that are developed on the RAM 12 etc.

Further, the CPU 11 executes programs (which will hereinafter be referred to as terminal programs) for managing the information of the removable device, thereby realizing functions as a terminal information collecting unit 111, a program information collecting unit 112, a device status monitoring unit 113, a device information acquiring unit 114, an information processing unit 115, a communication unit (transmission control unit) 116, an information archive unit (information formatting unit) 118, an update application checking unit 119, an update applying unit 110, and a device setting information collecting unit 120.

The terminal information collecting unit 111 of the CPU 11, when the device status monitoring unit 113 detects the connection of the removable device, acquires the terminal information on the user terminal 1 by reading the terminal information from a predetermined storage unit. This terminal information is exemplified such as identifying information of the user terminal 1, a name and a version of the OS, a model number of the CPU 11, a model number of a motherboard, a model number of a chipset, a name and a version of BIOS (Basic Input/Output System), etc. Note that a piece of information, if enabling identification of each user terminal 1 of the management system 10, is sufficient as the identifying information of the user terminal 1 and is exemplified by information allocated beforehand to each user terminal 1 and stored in the auxiliary storage device 14, a MAC (Media Access Control) address allocated to the communication control unit 16, a serial number of the motherboard and a serial number of the hard disk. Further, the predetermined storage unit, from which the terminal information is read, is, e.g., the ROM within the communication control unit 16 in the case of the MAC address, and the RAM 12 or the auxiliary storage device 14 stored with registry information of the OS in the case of the model number of the CPU 11 and the model number of the motherboard, i.e., the storage unit stored with various items of information.

The program information collecting unit 112 acquires items of information of application software and driver, which are installed into the user terminal 1, by reading these items of software information from the RAM 12 and the auxiliary storage device 14. To be specific, names, versions, etc of the application software and the driver are acquired from OS registry areas within the RAM 12 or the auxiliary storage device 14.

The device status monitoring unit 113 of the CPU 11 monitors a connection status of the removable device that is detachably connected to the I/O interface 15 and, when the removable device is connected thereto, notifies the terminal information collecting unit 111, the program information collecting unit 112 and the device information acquiring unit 114 of this purport (connection status). Specifically, the I/O interface 15 detects, as a change in electric characteristic of a terminal within a connector such as a USB port, that the removable device is connected to this connector, and notifies the device status monitoring unit 113 of the connection thereof, while the device status monitoring unit 113 (CPU 11) recognizes this connection.

The device information acquiring unit 114 of the CPU 11 acquires, when notified of the removable device's being connected, the device information on the removable device from the predetermined storage unit. For example, the device information acquiring unit 114 reads pieces of identifying information (a vendor ID and a product ID) from the ROM of the connected removable device, and further reads the driver information and the software information each associated with this identifying information out of the auxiliary storage device 14. Incidentally, as in such a case that the removable device, which supports Universal Plug and Play (protocol), is connected to the user terminal 1, if API (Application Program Interface) of the OS provides the information saying that the removable device is connected and the device information of the removable device, these items of information may also be utilized.

The information converting unit 115 converts, in a predetermined format for transmission to the management server, items of information (which will hereinafter be referred to as acquired information) such as the terminal information collected by the terminal information collecting unit 111, the program information collected by the program information collecting unit 112 and the device information acquired by the device information acquiring unit 114.

The communication unit 116 of the CPU 11 functions as a transmission control unit which transmits the device information to the management server 2 via the network 5 and as a reception control unit which receives distribution data from the management server 2 via the network 5.

The device setting information collecting unit 120 of the CPU 11 collects pieces of information (device setting information) for prescribing operations, etc of the connected removable device from the predetermined storage unit. For example, the device setting information is read from the memory within the removable device when connecting the removable device. The device setting information is exemplified by [bordering of margin], [multi-feed sensitivity], etc in the case of a scanner and [type of ink cartridge], [setting of extension paper tray], etc in the case of a printer.

Note that the device setting information may also be stored in a predetermined folder within the auxiliary storage device 14 when installing the driver of the removable device and when the user performs inputting (setting). Namely, the device setting information collecting unit 120 may, when the removable device is connected, read the device setting information from any one or both of the auxiliary storage device 14 and the removable device information acquiring unit 114.

The information archive unit 118 of the CPU 11 generates an archive (update data (program for updating) to be distributed) in a predetermined format by adding the device identifying information and an update condition to the device setting information received from the device setting information collecting unit 120, and transmits the thus-generated update data to the administrator terminal 3.

The update application checking unit 119 of the CPU 11 compares update data applied information of the for-the-distribution update data received from the management server 2 with the terminal information, the device information and the program information within the user terminal 1, thus determining whether the update data applied information is matched or not.

The update applying unit 110 of the CPU 11 updates, based on the for-the-distribution update data, the driver, the application and the setting values thereof.

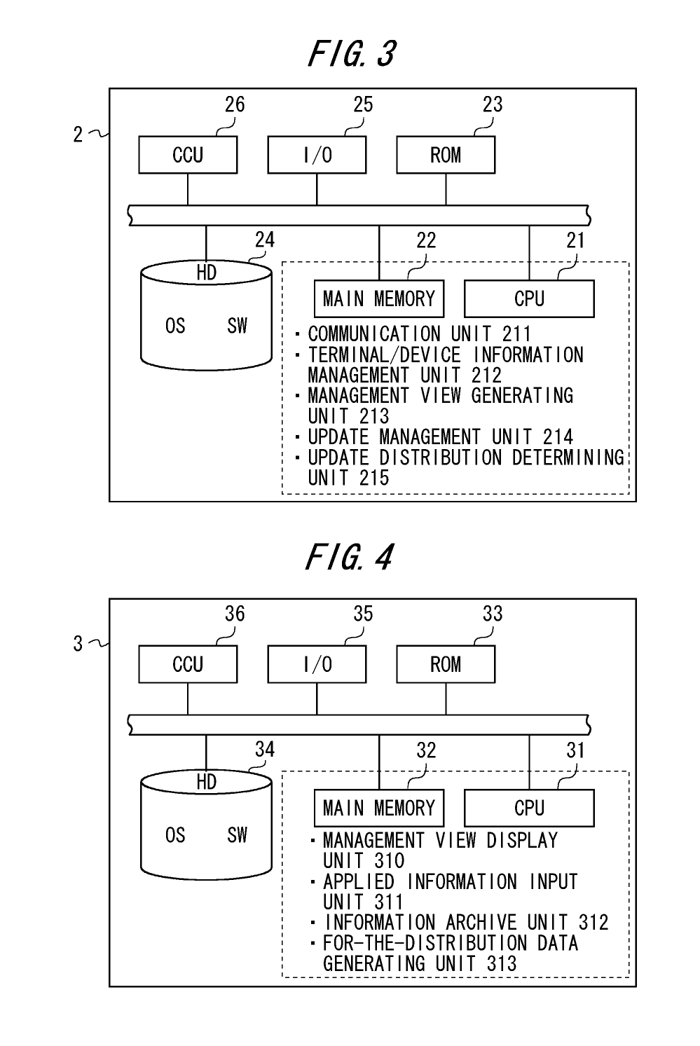

On the other hand, FIG. 3 is a diagram illustrating an outline of a configuration of the management server 2 according to the embodiment. The management server 2 is a computer including a CPU 21, a RAM 22, a ROM 23, an auxiliary storage device 24, an Input/Output (I/O) interface 25 and a communication control unit 26.

The RAM 22 is a so-called main memory (main storage device) from and to which the CPU 21 reads and writes a variety of instructions and data.

The auxiliary storage device 24 is a storage device, which is permanently stored with a large quantity of information and auxiliary to the volatile RAM 22, and is exemplified by the HDD and the SSD.

The I/O interface 25 is the interface for connecting with the input/output means and for inputting and outputting the signals. A console (including a keyboard and a display) and reading/writing device of the storage medium etc. are properly connected as the input/output means to the I/O interface 25.

The communication control unit 26 establishes the connections with other computers via the network 5, and controls the communications with other computers in accordance with the instruction given from the CPU 21.

The CPU 21 is the central processing unit and controls the RAM 22, the auxiliary storage device 24, the communication control unit 26, the input/output means, etc by processing the instructions and the data that are developed on the RAM 22 etc.

Further, the CPU 21 executes programs (which will hereinafter be referred to as management server programs) for managing the information of the removable device, thereby realizing functions as a communication unit 211, a terminal/device information management unit 212, a management view generating unit 213, an update management unit 214 and an update data distribution determining unit 215.

The communication unit 211 of the CPU 21 performs the communications with the user terminal 1 and the administrator terminal 3 via the network 5 under the control of the communication control unit 26. For example, the communication unit 211 functions as a transmission control unit which transmits the data for distribution to the user terminal 1 and as a reception control unit which receives the data from the user terminal 1.

The terminal/device information management unit 212 of the CPU 21 manages the terminal information and the device information received from the user terminal 1. The terminal/device information management unit 212 in the embodiment functions as a device information registering unit which registers the device information received from the user terminal 1 in a database of the auxiliary storage device 24 in the way of being associated with the terminal information of the user terminal 1 defined as a sender. Further, the terminal/device information management unit 212 also functions as a management unit which outputs the management information on the basis of the terminal information, the device information and the program information.

The management view generating unit 213 of the CPU 21, when receiving the management information from the terminal/device information management unit 212, generates a management view in a predetermined format and transmits the management view to the administrator terminal 3.

The update management unit 214 of the CPU 21 stores the for-the-distribution update data received from the administrator terminal 3 in the auxiliary storage device 24.

The update data distribution determining unit 215 of the CPU 21, when receiving the device information, the terminal information and the program information after the removable device has been connected to the user terminal 1, determines whether or not these items of information are matched with the update applied information of the for-the-distribution update data stored in the auxiliary storage device 24 and decides that for-the-distribution update data should be applied if matched, and this for-the-distribution update data is read by the update management unit 214 and transmitted to the user terminal 1 via the communication unit 211.

Further, FIG. 4 is a diagram illustrating an outline of a configuration of the administrator terminal 3 according to the embodiment. The administrator terminal 3 is a computer including a CPU 31, a RAM 32, a ROM 33, an auxiliary storage device 34, an Input/Output (I/O) interface 35 and a communication control unit 36.

The RAM 32 is the so-called main memory (main storage device) from and to which the CPU 31 reads and writes the variety of instructions and data.

The auxiliary storage device 34 is the storage device, which is permanently stored with a large quantity of information and auxiliary to the volatile RAM 32, and is exemplified by the HDD and the SSD.

The I/O interface 35 is the interface for connecting with the input/output means and for inputting and outputting the signals. A keyboard, a display and reading/writing device of the storage medium etc. are properly connected as the input/output means to the I/O interface 35.

The communication control unit 36 establishes the connections with other computers via the network 5, and controls the communications with other computers in accordance with the instruction given from the CPU 31.

The CPU 31 is the central processing unit and controls the RAM 32, the auxiliary storage device 34, the communication control unit 36, the input/output means, etc by processing the instructions and the data that are developed on the RAM 32 etc.

Further, the CPU 31 executes application programs, thereby realizing functions as a management view display unit 310, an applied information input unit 311, an information archive unit 312 and a for-the-distribution data generating unit 313.

The management view display unit 310 displays, based on the management view data received from the management server 2, the management view on the display.

The applied information input unit 311 presents an input window for inputting the applied information such as a setting value and an applied condition to the administrator in a way that displays this input window on the display, and the applied information, which is inputted by the administrator's operating the input/output means such as the keyboard, is transmitted to the information archive unit 312 and is stored in the auxiliary storage device 34.

The information archive unit 312 acquires the driver of the removable device and the update data by connecting with servers of vendors of the application software and of the removable device via the network 5, and stores thus-acquired software and data in the auxiliary storage device 34.

The for-the-distribution data generating unit 313 reads the applied information inputted via the applied information input unit 311 and the for-the-distribution data acquired by the information archive unit 312 from the auxiliary storage device 34, and the management unit of the CPU 31 outputs the management information on the basis of the device information.

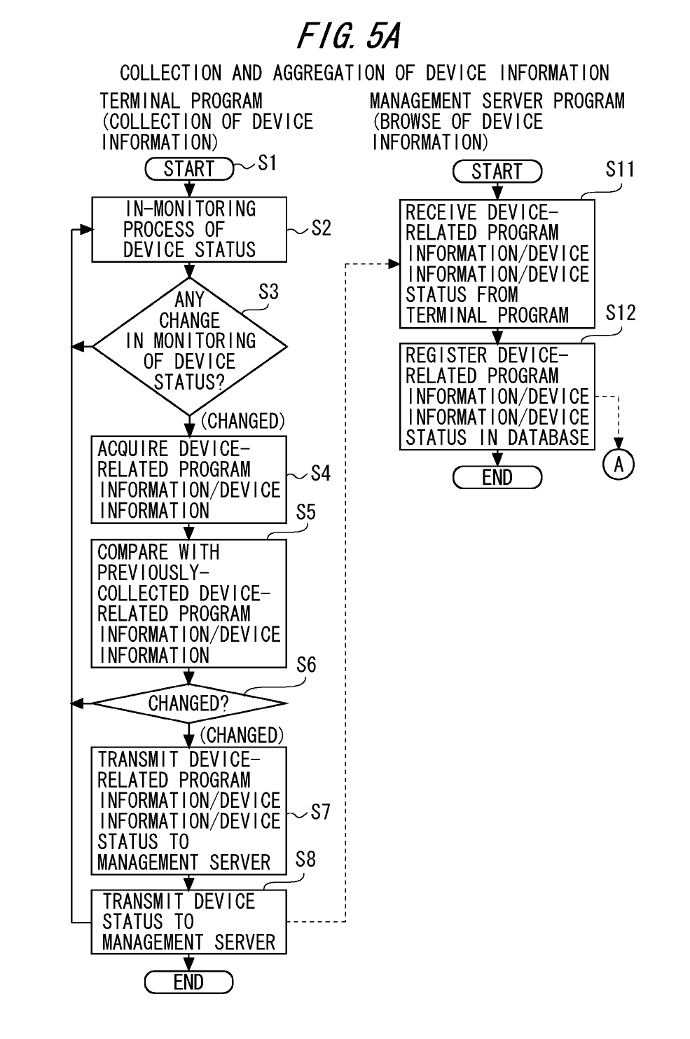

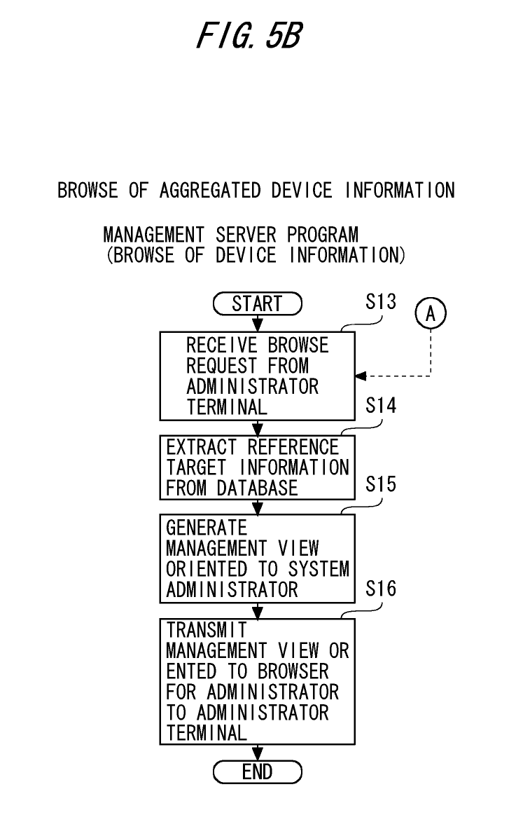

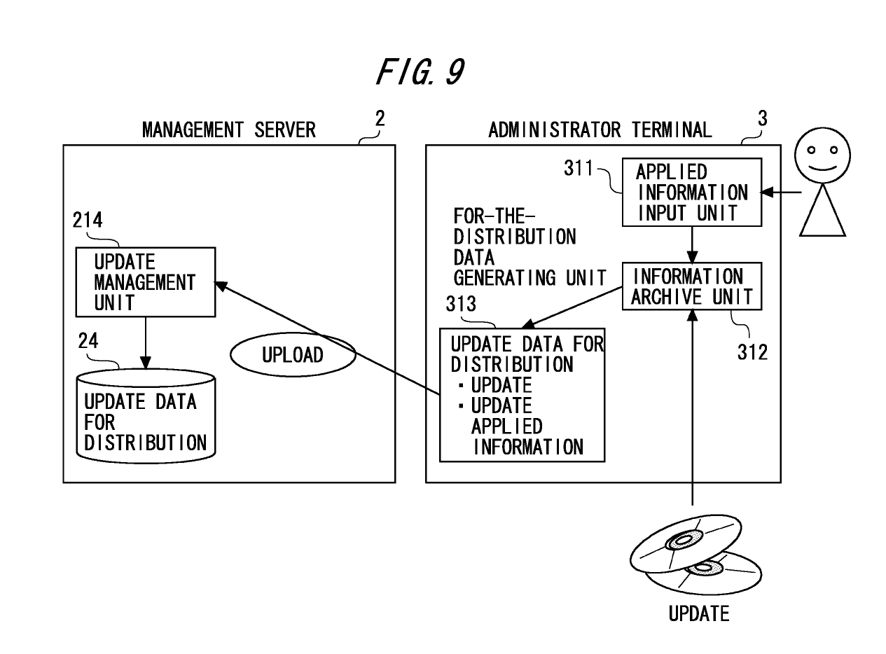

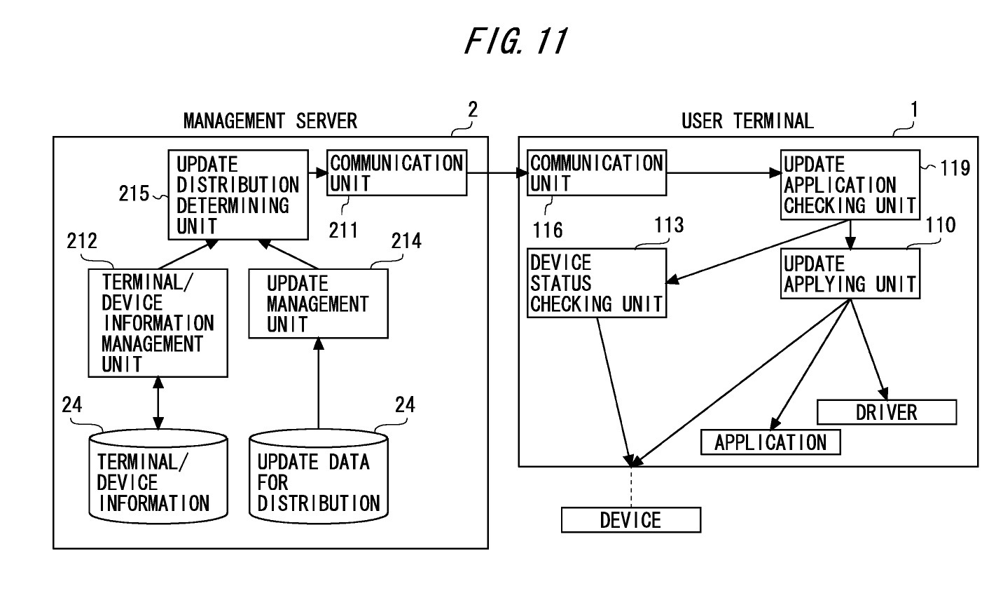

A management method of the removable device, which is executed by the user terminal 1 and the management server 2 each having the configuration described above, will hereinafter be described with reference to FIGS. 5-11. FIGS. 5-11 are explanatory diagrams of the management method of the removable device in this first embodiment.

<Collection and Aggregation of Device Information>

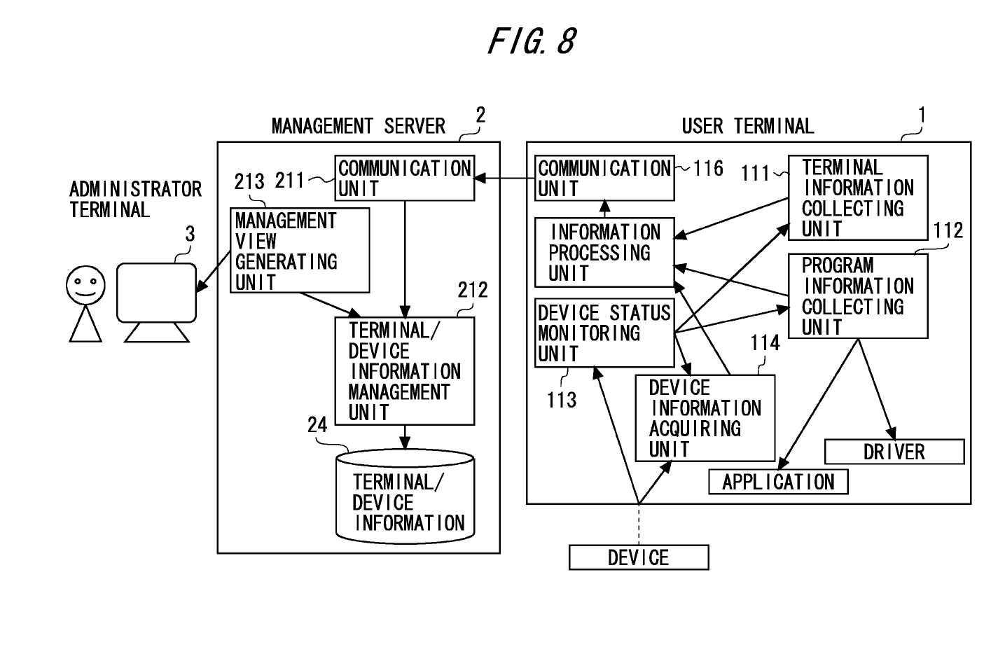

To begin with, the management server 2 distributes the terminal program for monitoring a connected status of the removable device to the user terminal 1 connected via the network 5, while the user terminal 1 executes the terminal program and gets this program to reside in the terminal 1. With this resident program, the user terminal 1 starts managing the removable device as illustrated in FIGS. 5(A), 5(B) and 8, the device status monitoring unit 113 monitors a status of the device (step S2). If a change occurs in the device status upon establishing the connection of the removable device (step S3), the device status monitoring unit 113 notifies the terminal information collecting unit 111, the program information collecting unit 112 and the device information acquiring unit 114 of this purport.

When notified of this connection of the removable device, the terminal information collecting unit 111 collects the terminal information, the program information collecting unit 112 collects the program information, the device information acquiring unit 114 acquires the device information, and these items of information are transmitted to the information processing unit 115 (step S4).

The information processing unit 115 determines whether there is a change or not by comparing theses items of received information with the previous transmission information, and transmits, if there is the change, these items of information to the management server 2 via the network 5 (steps S7, S8).

The terminal/device information management unit 212 of the management server 2, which receives these items of information via the communication unit 211, accumulates the received device information in the way of being associated with the sender terminal information (step S11) in the database of the auxiliary storage device 24 (step S12).

Then, when receiving a browse request from the administrator terminal 3 (step S13), the terminal/device information management unit 212 of the management server 2 extracts the requested information by referring to the information accumulated in the database (step S14) and transmits the extracted information to the management view generating unit 213, while the management view generating unit 213 generates the management view (which is, e.g., a WEB page in the HTML (hypertext Markup Language) format) (step S15) and transmits this generated management view to the administrator terminal 3, thereby enabling the administrator to conduct integrated management of the device (step S16).

<Simultaneous Application of Update Data for Updating Device>

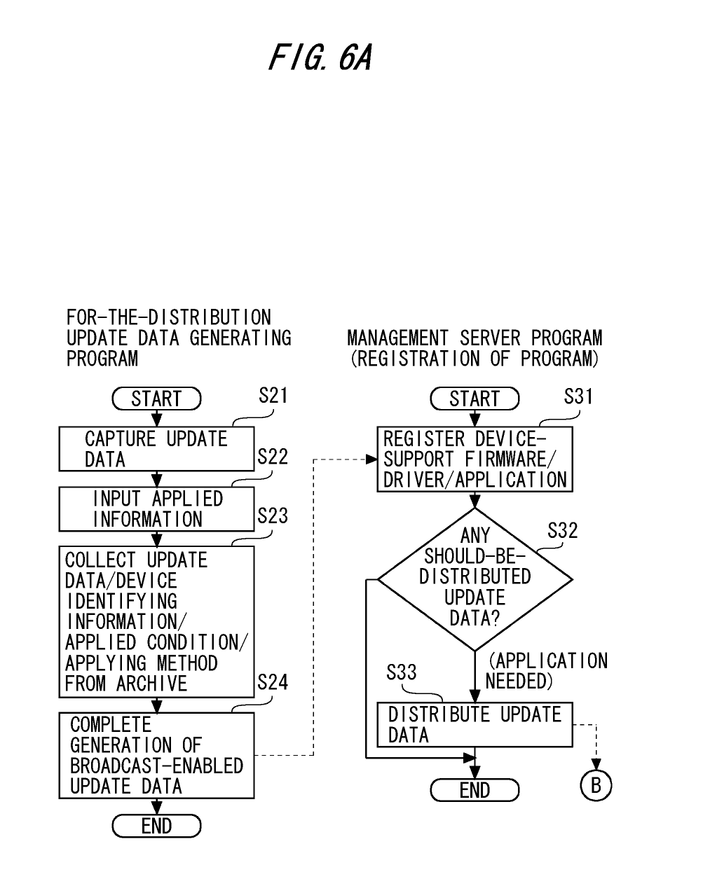

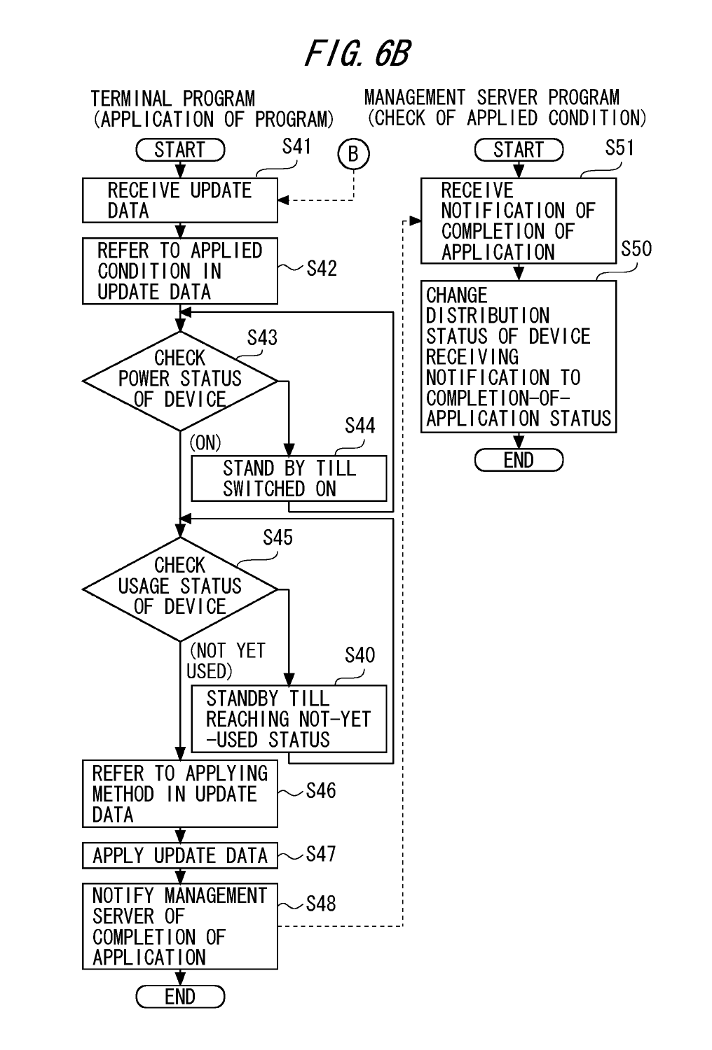

FIGS. 6(A), 6(B), 9 and 11 are explanatory diagrams for simultaneously distributing the update data for updating the information of the removable device.

When the information archive unit 312 of the administrator terminal 3 receives the update data corresponding to an operation of the system administrator (step S21), the applied information input unit 311 prompts the administrator to input the applied information and receives the input of this applied information (step S22). For example, a distribution range (i.e., a range of the user terminals as a distribution target range) and a distribution schedule (such as distribution time and a distribution target monitoring time interval) are set as the applied information.

The for-the-distribution data generating unit 313 receives the update information and the applied information from the applied information input unit 311 and the information archive unit 312 (step S23), then generates the simultaneously-distributable update data for the distribution and uploads the generated update data to the management server 2 (step S24).

When the management server 2 receives the update data for the distribution from the administrator terminal 3, the update management unit 214 registers the update data for the distribution in the auxiliary storage device 24 (step S31).

Then, when receiving the acquired information from the user terminal 1 in such a case that the removable device is connected, the update distribution determining unit 215 determines whether or not there is the update data that should be distributed (step S32) and, if there is should-be-distributed update data, distributes the update data to the user terminal 1 (step S33).

When the user terminal 1 receives the update data for the distribution from the management server 2 (step S41), the update application checking unit 119 compares the terminal information, the program information and the device information within the user terminal 1 with the update applied information of the update data, thus checking whether these items of information are matched with each other or not (step S42). If matched, the update applying unit 110 checks a power status of the device (step S43) and, if the power is OFF, stands by till the power is set ON (step S44).

Whereas if the power of the device is ON, the update applying unit 110 checks a usage status of the device (step S45). For example, the update applying unit 110 refers to the status of the removable device and, if busy, decides that the removable device is in the process of being used. If the removable device is in the usage status, the update applying unit 110 stands by till the device becomes a not-yet-used status (step S40) and, when reaching the not-yet-used status, refers to an application method contained in the update data for the distribution (step S46). For example, an update sequence and a necessity for a restart-up after the update are checked based on this applying method.

Then, the update applying unit 110 applies the update data for the distribution (step S47) and, when completed, notifies the management server 2 of completion of the application (step S48).

When the management server 2 receives the completion-of-application notification (step S51), the update management unit 214 stores, in the auxiliary storage device 24, the information saying that the application of the for-the-distribution update data transmitted to the user terminal 1 has been completed and updates this status (step S52).

<Simultaneous Application of Setting Information of Device>

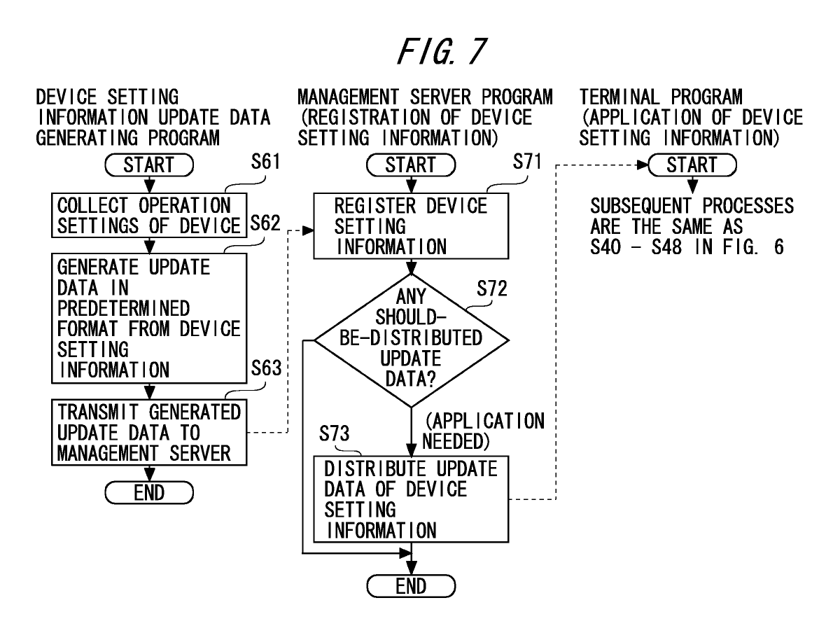

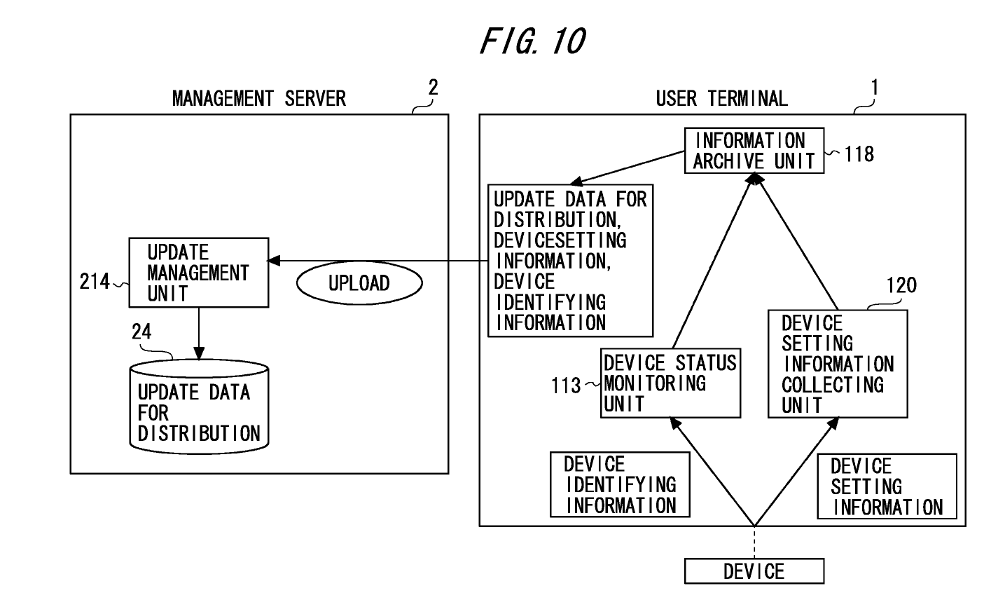

FIGS. 7 and 10 are explanatory diagrams on the occasion of, in the user terminal 1, collecting the items of information set in the device itself and set in the device-related driver and the device-related application, then generating an archive file conforming to a for-the-distribution update data format by adding the device identifying information, the application condition and the application method to the collected information, and performing the simultaneous application.

In the user terminal 1, when the removable device is connected thereto, the device setting information collecting unit 120 collects the information set in the device, the information set in the device-related driver and the information set in the device-related application, i.e., the device setting information from the predetermined storage units such as the memory in the removable device and the auxiliary storage device 14 (step S61).

The information archive unit 118 generates the for-the-distribution update data in the predetermined format by adding the device identifying information and the application condition to the device setting information (step S62), and transmits the generated update data to the management server 2 (step S63).

In the management server 2, when receiving the for-the-distribution update data of the device setting information from the user terminal 1, the update management unit 214 registers the for-the-distribution update data in the auxiliary storage device 24 (step S71).

Then, when the acquired information given in the case of the removable device's being connected is received from the user terminal 1, the update distribution determining unit 215 determines whether there is the should-be-distributed update data of the setting information or not (step S72), and, if there is the should-be-distributed update data of the setting information, for example, the update data of the device setting information is distributed to the user terminal 1 in such a case that there exists the device setting information updated by the administrator's changing the should-be-simultaneously-applied settings from on the administrator terminal 3 (step S73).

The user terminal 1 receiving the update data of the device setting information applies the update data of the device setting information in the same way as steps S40-S48 in FIG. 6(A), FIG. 6(B).

As discussed above, according to the embodiment, the user terminal acquires and transmits the information of the removable device to the management server to thereby enable the overall management to be done on the side of the management server, and the management server can manage the information in a way that updates the information of the removable device and applies the device setting information when the removable device is connected to the user terminal.

It should be noted that the administrator terminal 3 may include all of the functions provided in the user terminal 1 illustrated in FIG. 10.

What is claimed is:

1. A management system of a removable device, comprising a management server and an information processing terminal that are connected to each other via a network,
the information processing terminal including:
a device information acquiring unit to monitor a connection status of a removable device which is detachably connected to the information processing terminal itself, and to acquire, when the removable device is connected thereto, device information related to the removable device from a predetermined storage unit; and
a transmission control unit to transmit the device information to the management server via the network,
the management server including:
a device information registering unit to register the device information received from the information processing terminal in the way of being associated with information of the sender information processing terminal in a database; and
a management unit to output management information on the basis of the device information.

2. A management system of a removable device according to claim 1, wherein the device information contains at least one of identifying information of the removable device, a level of firmware of the removable device, identifying information of a driver of the removable device, a version of the driver, identifying information of application software using the removable device, version information of the application software, a setting value related to the removable device and change information of the setting value.

3. A management system of a removable device according to claim 1, wherein the management server includes a distribution determining unit which is stored with, in the way of being added to the device information, applied information containing an applied condition of the device information and determines based on the applied information whether the device information should be distributed to the information processing terminal or not.

4. A management system of a removable device according to claim 1, wherein the management server includes a transmitting unit to transmit the device information to the information processing terminal, and
the information processing terminal includes an applying unit to check a usage status of the removable device and to update the device information of the removable device with the device information received from the management server.

5. A management system of a removable device according to claim 1, further comprising:
a setting information collecting unit to collect the setting information related to the removable device in the device information by reading the setting information from the predetermined storage unit of the removable device; and
an information formatting unit to format the setting information related to the removable device in a data of a predetermined format and to transmit the formatted setting information to the management server.

6. A management method of a removable device, executed by a management server and an information processing terminal that are connected to each other via a network,
the information processing terminal executing:
monitoring a connection status of a removable device which is detachably connected to the information processing terminal itself, and acquiring, when the removable device is connected thereto, device information related to the removable device from a predetermined storage unit; and
transmitting the device information to the management server via the network,
the management server executing:
registering the device information received from the information processing terminal in the way of being associated with information of the sender information processing terminal in a database; and
outputting management information on the basis of the device information.

7. A non-transitory readable-by-computer recording medium recorded with a management program of a removable device, executed by a management server and an information processing terminal that are connected to each other via a network,
the program making the information processing terminal execute:
monitoring a connection status of a removable device which is detachably connected to the information processing terminal itself, and acquiring, when the removable device is connected thereto, device information related to the removable device from a predetermined storage unit; and
transmitting the device information to the management server via the network,
the program making the management server execute:
registering the device information received from the information processing terminal in the way of being associated with information of the sender information processing terminal in a database; and
outputting management information on the basis of the device information.
